(19) United States
(12) Patent Application Publication
(10) Pub. No.: US 2010/0220774 A1
(43) Pub. Date: Sep. 2, 2010

(54) LOW POWER UWB TRANSMITTER AND RECEIVER IN IMPULSE-BASED UWB COMMUNICATION SYSTEM AND METHOD FOR OPERATING THE SAME

(76) Inventors: Joo Ho Park, Daejeon (KR); Mi Kyung Oh, Gyeongbuk (KR); Young Joon Ko, Daejeon (KR); Jae Young Kim, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/681,479

(22) PCT Filed: Jul. 11, 2008
(86) PCT No.: PCT/KR08/04106

§ 371 Date: Apr. 2, 2010

(30) Foreign Application Priority Data
Oct. 4, 2007 (KR) 10-2007-0099616

(51) Int. Cl. H04L 5/16; H04L 27/00

(52) U.S. Cl. 375/222; 375/295

(57) ABSTRACT

Provided are an ultra wideband (UWB) system and a method for operating the same. The UWB system includes a baseband unit for modulating/demodulating an impulse data signal and generating a power management control signal using burst hopping information, and an RF transmitting/receiving unit for transmitting/receiving a wireless signal and alternating between power-on/off states according to the power management control signal generated from the baseband unit. The UWB system can reduce power consumption by applying power source to the RF transmitting/receiving unit only at a time interval in which an impulse signal having a short time period and constituting transmitting/receiving data exists.

### TECHNICAL FIELD

The present disclosure relates to low power ultra wideband (UWB) transmitter and receiver in an impulse-based UWB communication system and a method for operating the same, and more particularly, to a system structure and a power management method capable of minimizing the power consumption in an impulse-based UWB communication system.

This work was supported by the IT R&D program of MIC/IITA.

[2006-S-070-02, Development of Cognitive Wireless Home Networking System]

### BACKGROUND ART

An ultra wideband (UWB) communication scheme refers to a wireless communication scheme using a bandwidth of more than 500 MHz or fractional bandwidth of greater than 20%. The impulse-based UWB communication is a technology for transmitting signals by performing up-conversion to a specific bandwidth of an RF frequency using a narrow impulse less than several ns.

The impulse-based UWB wireless communication system is applicable to a system for determining a high-accuracy location, because the impulse-based UWB communication uses a much shorter pulse width. Moreover, when the UWB wireless communication system consumes low power, the UWB wireless communication system can be used for a sensor node or a high-accuracy location-aware device by being mounted onto a mobile phone or a mobile device. Accordingly, active research is in progress on this point.

With respect to a reduction of power consumption, related-art devices for UWB wireless communication system are configured to have such a structure and a circuit as to maintain RF transmitting/receiving units consuming much power to be on or off state according to a transmitting mode or a receiving mode.

However, in the related art configuration, the RF transmitting or receiving unit always operates during data transmission and reception. Accordingly, even when discontinuous data is transmitted and received based on a data packet communication, power is applied to the RF transmitting/receiving units which consume much power according the transmitting or receiving mode. Accordingly, there is a limitation to reduce power consumption.

In the impulse-based UWB wireless system as illustrated in FIG. 6, impulse signals corresponding to information of 1 or −1 are generated with respect to each bit constituting data symbols for data transmission and reception. Locations of the impulse signals are determined in the symbols by a combination of predetermined burst hopping signals. The locations of the impulse signals mean data information. Accordingly, an interval in which the impulse exists corresponds to a portion of the symbol. In particular, time T_{burst} taken to transmit/receive actual impulse signals for every time period T_{symbol} (approximately 1 us) of one symbol is only several tens of ns because the symbol includes a protection interval.

Subsequently, in the related art UWB wireless communication system, the RF transmitting/receiving units consume power without transmission or reception of signals for a time longer by several ten times than a time for actual transmission/reception of signals.

Therefore, development of a scheme for minimizing the power consumption of the RF transmitting/receiving units is required to transmit and receive data using the impulse-based UWB wireless system.

### DISCLOSURE OF INVENTION

### Technical Problem

Therefore, an object of the present invention is to provide low power ultra wideband (UWB) transmitter and receiver in an impulse-based UWB communication system and a method for operating the same, which may reduce the power consumption by applying power source to RF transmitting/receiving units only at a time interval in which an impulse signal having a short time period and constituting transmitting/receiving data exists.

### Technical Solution

To achieve these and other advantages and in accordance with the purpose(s) of the present invention as embodied and broadly described herein, a low power ultra wideband (UWB) transmitter for an impulse-based UWB wireless system in accordance with an aspect of the present invention includes: a baseband unit for modulating an impulse data signal and generating a power management control signal using a burst hopping information; and an RF transmitting unit for transmitting a wireless signal and alternating between power-on/off states according to the power management control signal generated from the baseband unit.

To achieve these and other advantages and in accordance with the purpose(s) of the present invention, a low power UWB receiver for an impulse-based UWB wireless system in accordance with another aspect of the present invention includes: a baseband unit for demodulating an impulse data signal and generating a power management control signal using a burst hopping information; and an RF receiving unit for receiving a wireless signal and alternating between power-on/off states according to the power management control signal generated from the baseband unit.

To achieve these and other advantages and in accordance with the purpose(s) of the present invention, an apparatus a method for operating a low power UWB transmitter for an impulse-based UWB wireless system in accordance with further another aspect of the present invention includes: generating an impulse data signal by modulating a transmission data according to a burst hopping information; generating a power management control signal according to the burst hopping information; transmitting the impulse data signal and the power management control signal into an RF transmitting unit; and transmitting the impulse data signal by alternating power-on/off states of the RF transmitting unit according to the power management control signal.

### Advantageous Effects

Low power ultra wideband (UWB) transmitter and receiver in an impulse-based UWB communication system and a method for operating the same according to the present invention may reduce the power consumption and manage power efficiently by applying power source to RF transmitting/receiving units only at a time interval in which an impulse signal having a short time period and constituting transmitting/receiving data exists.

### BRIEF DESCRIPTION OF THE DRAWINGS

FIG. 1 is a diagram illustrating a frame structure of an ultra wideband (UWB) system defined by IEEE 802.15.4a standard of the present invention.

FIG. 2 is a diagram illustrating a symbol of a synchronization header frame constituting a frame of the ultra wideband system as illustrated in FIG. 1.

FIG. 3 is a diagram illustrating a symbol of a PHY header frame constituting a frame of the ultra wideband system as illustrated in FIG. 1.

FIG. 4 is a block diagram illustrating a basic configuration of an ultra wideband system according to an embodiment of the present invention.

FIG. 5 is a block diagram illustrating RF transmitting/receiving units in UWB transmitting/receiving system according to an embodiment of the present invention.

FIG. 6 is a diagram illustrating a generation of an impulse signal and a power management control signal using a burst hopping location information in a symbol according to an embodiment of the present invention.

FIG. 7 is a diagram illustrating a power management control signal according to an embodiment of the present invention.

### BEST MODE FOR CARRYING OUT THE INVENTION

Hereinafter, specific embodiments will be described in detail with reference to the accompanying drawings, in which like numerals refer to like parts.

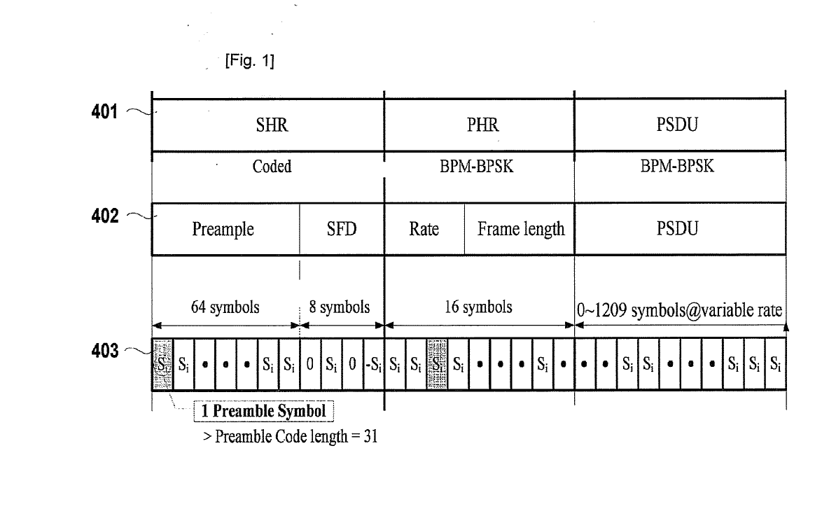

FIG. 1 is a diagram illustrating a frame structure of an ultra wideband (UWB) system defined by the IEEE 802.15.4a standard, according to the present invention.

Referring to FIG. 1, a data frame includes a synchronization header (SHR), a PHY header, a PHY service data unit (PSDU). The synchronization header includes 64 preamble symbols and 8 start-of-frame delimiter symbols and is directly modulated into a code. The PHY header includes 16 symbols having a data rate and a frame length. The PSDU includes a maximum of 1209 symbols, but may vary with the amount of data. The PHY header and the PSDU is modulated by a burst position modulation-binary phase-shift keying (BPM-BPSK) scheme.

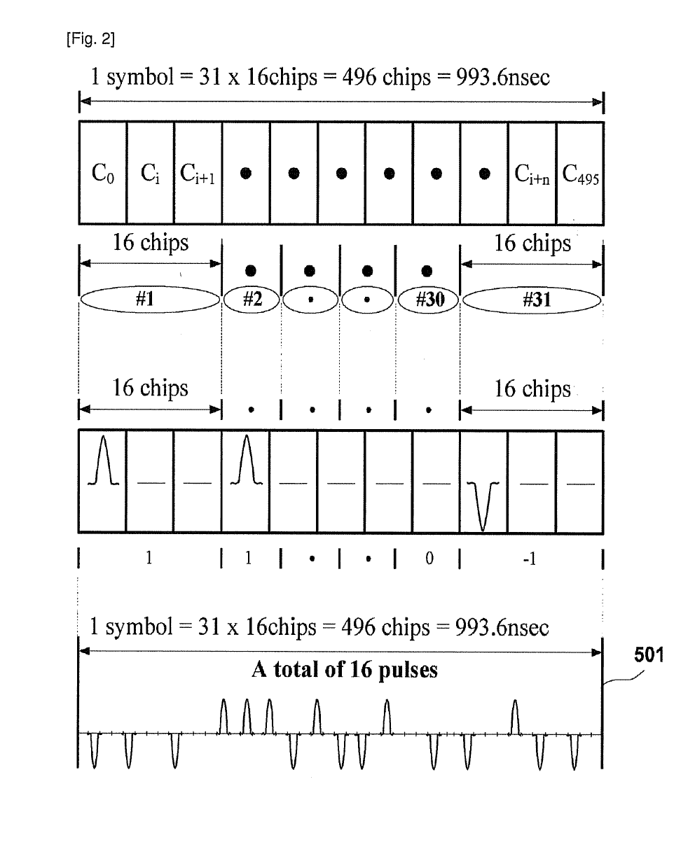

FIG. 2 is a diagram illustrating a symbol of a synchronization header frame constituting a frame of the ultra wideband system in illustrated in FIG. 1.

Referring to FIG. 2, one symbol of the synchronization header frame includes 31 sequences, and forms a ternary sequence by sixteen combinations of 1 or −1. In this case, 1 or −1 is directly mapped into an impulse of several ns to generate data.

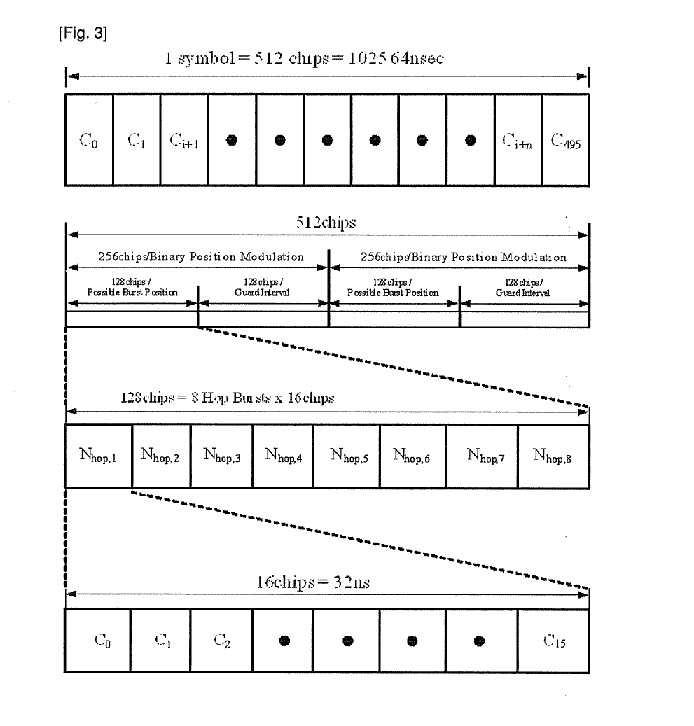

FIG. 3 is a diagram illustrating a symbol of a PHY header frame constituting a frame of the ultra wideband system in illustrated in FIG. 1.

Referring to FIG. 3, the PHY header includes 16 symbols and carries information such as a data rate and a frame length. As described above, the PHY header and the PSDU has such a structure that data may be determined from a generation location of an impulse by generating the impulse according to a burst hopping by the BPM-BPSK scheme. In one symbol including 512 chips corresponding to 1025.64 ns, a region in which a pulse exists is only 16 chips corresponding to one hop.

That is, 512 chips are divided into two regions of 256 chips, respectively. The pulse exists only in one of the two regions. Moreover, each region of 256 chips includes an interval (128 chips) in which a pulse is able to exist and a protection interval (128 chips). In a BPM-BPSK scheme, an interval in which actual pulse may be generated is only an interval of 16 chips among an interval in which the pulse is able to exist because data value is determined from a location of the pulse. It can be understood that an interval, in which the pulse exists, is only an interval (32 ns) corresponding to 16 chips among one symbol interval (1025.64 ns) having 512 chips.

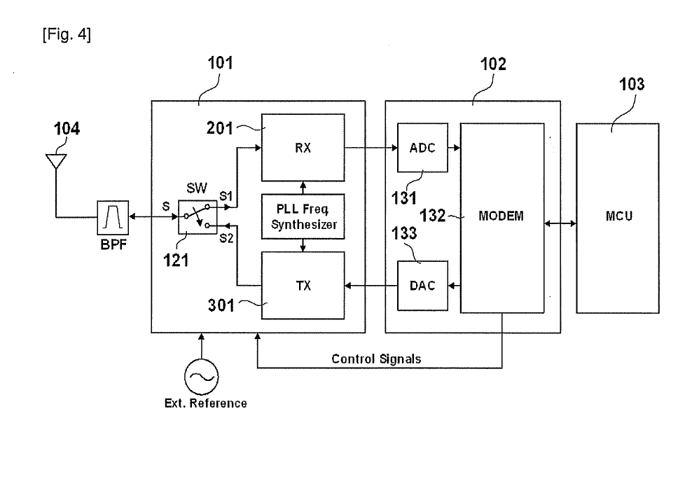

FIG. 4 is a block diagram illustrating a basic configuration of an UWB radio system according to an embodiment of the present invention.

Referring to FIG. 4, the UWB radio system includes an antenna 104, an RF transmitting/receiving unit 101, a baseband unit 102, and a micro controller unit (MCU) 103.

The antenna transmits or receives a wireless signal. The RF transmitting/receiving unit 101 may process the wireless signal transmitted and received via the antenna 104, and independently manage the power source. The baseband unit 102 modulates/demodulates an impulse data signal, and generates a time hopping control signal for a power management generated in a generation interval of data. The MCU controls the UWB radio system as a whole.

Since the UWB radio system employs a time-division duplexing scheme for transmitting and receiving data, the RF transmitting/receiving unit 101 is separated into an RF receiver 210 and an RF transmitter 301. Moreover, transmitting/receiving path is controlled by a switch 121.

The baseband unit 102 includes an analog-to-digital converter (ADC) 131, a digital-to-analog converter (DAC) 133, and a modulating/demodulating unit 132. On reception of data, the ADC 131 demodulates an analog signal into a digital signal on reception of data. On transmission of data, the DAC 133 modulates a digital signal into an analog signal. The modulating/demodulating unit 132 is connected to the ADC 131 and the DAC 133 to control the modulation/demodulation of the signals. The modulating/demodulating unit 132 is also connected to the MCU 103.

For a wireless communication in the impulse-based UWB system, an impulse data signal generated in the modulating/demodulating unit 132 of the baseband is transmitted into and received from a specific communication band. The data signal generated in the modulating/demodulating unit 132 of the impulse-based UWB system is an impulse signal having a short duration of several ns, which is generated only in a time interval of several tens of ns among one symbol interval (1 us) of data.

Accordingly, in the impulse-based UWB system, modulating/demodulating unit 132 generates a power management control signal so as to allow the RF transmitting/receiving unit 101 to be powered-on only in an interval in which a pulse exists. Subsequently, power-on or power-off of the RF transmitting/receiving unit 101 is controlled according to the power management control signal, thereby significantly reducing power consumption and confirming a stable operational state thereof.

The power management control signal may allow the RF transmitting/receiving unit 101 to be powered on for a time longer than a time when the pulse exists in consideration with a time required to stabilize an operation of the RF transmitting/receiving unit 101 immediately after a conversion between a powered-on state and a power-off state.

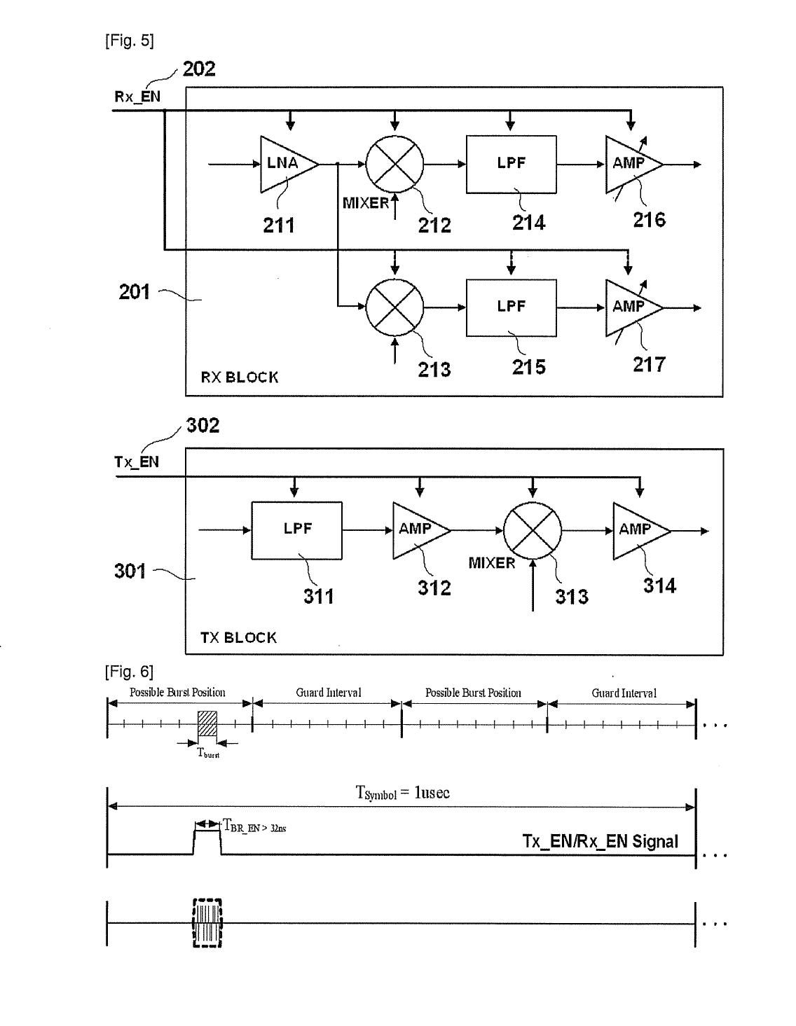

FIG. 5 is a block diagram illustrating RF transmitting/receiving units in UWB transmitting/receiving system according to an embodiment of the present invention.

Referring to FIGS. 4 and 5, a process of transmitting and receiving data will be described as follows.

When the impulse-based UWB system is operated in a transmission mode, the baseband unit 102 transmits a random pulse according to a generated data into the RF transmitting unit 301 via the DAC 133. Since the randomly generated data impulse signal is transmitted in accordance with a frame structure as described above with reference to FIG. 1, the RF transmitting unit 301 is powered on only in an interval in which actual impulse signal exists and powered off in an interval in which a pulse is absent. In this way, power consumption in the RF transmitting unit 301 can be reduced. The impulse signal transmitted into the RF transmitting unit 301 is transmitted into the antenna 104 via a low-pass filter 311, an amplifier 312, a frequency down convert 313 and an amplifier 314.

The SHR including a preamble and a SFD includes a ternary sequence to generate a random pulse. However, it is difficult to stably supply power into the RF transmitting unit 301 due to a setup time for applying power source and a response characteristic when the power management control signal is generated after checking whether the generated pulse exists. Accordingly, for a stable power management, the control signal (Tx_EN signal; 302) may be applied so that the RF transmitting unit 301 may be powered on during the entire frame when the pulse of the synchronization header is generated.

However, since a location of a pulse corresponds to data in the PHY header, the RF transmitting unit 301 is powered on only in an interval in which the pulse exists and powered off in an interval in which the pulse is absent. Since the pulse constituting the PHY header is generated only at 32 ns in a symbol of 1 μs, other intervals maintain the absence of the pulse. A control signal (Tx_EN signal; 302) for managing power of the RF transmitting unit 301 is generated and applied to the RF transmitting unit 301 using a burst hopping information for determining the pulse location because the generation location of the pulse becomes data. The RF transmitting unit 301 maintains the power-on state only in an interval into which the pulse is generated and transmitted at the baseband unit 102 and the power-off state in an interval in which the pulse is absent, thereby reducing the power consumption thereof.

When the impulse-based UWB system is operated in a reception mode, a wireless signal is received via the antenna 104 and transmitted into the RF receiving unit 201 of the UWB system. The RF receiving unit 201 may not know whether a pulse signal exist regarding the signal received via the antenna 104, but know only strength the received signal. However, power management must be performed using the procedures performed in the RF transmitting unit 301 in order to power on/off the RF receiving unit 201. To convert the wireless signal into a baseband signal, the received signal is amplified by a variable gain amplifier (216 or 217) after passing through a lower noise amplifier 211, a frequency down converter (212 or 213) and a low-pass filter (214 or 215) to maintain a constant signal level, and inputted into the ADC 131. The signal outputted from the ADC 131 is inputted into the modulating/demodulating unit 132, and demodulated to data. Similarly, a frame of the received signal includes a synchronization header, a PHY header and a PSDU. Accordingly, the RF receiving unit 201 is maintained in a powered-on state at an initial synchronization header, and a control signal (Rx_EN signal; 202) for managing power is applied to the RF receiving unit 201 by pre-operating a hopping routine in order to find a location of the pulse in the PHY header and the PSDU. Subsequently, the power consumption in the RF receiving unit 201 can be reduced.

Regarding the received signal in the baseband unit, after the hopping routine is pre-operated to find a location of the pulse, a control signal (Rx_EN signal; 202) for managing power is generated using a burst hopping information by reflecting a setup time required for a stable operation of the RF receiving unit 201 and an interval in which the pulse exists. The control signal is applied to the RF receiving unit 201 to alternate power-on/off states of the RF receiving unit 201, thereby reducing the power consumption through an efficient power management and the stable operation of the RF receiving unit 201.

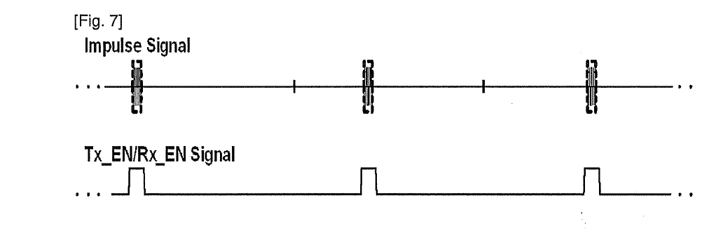

FIG. 6 is a diagram illustrating a generation of an impulse signal and a power management control signal using a burst hopping location information in a symbol according to an embodiment of the present invention. FIG. 7 is a diagram illustrating a power management control signal according to an embodiment of the present invention.

Referring to FIGS. 6 and 7, for a data communication, an impulse signal corresponding to information of 1 or −1 with respect to each bit constituting a data symbol is generated. The impulse signal is transmitted/received for a time T_{burst} every time period T_{symbol} of one symbol. A location of the impulse signal is determined by a combination of a predetermined burst hopping signals. The location of the impulse signal means data information. Control signals Tx_EN and Rx_EN are generated by reflecting a setup time required for a stable operation of the RF transmitting/receiving units 301 and 201 and an interval in which the pulse exists using the burst hopping information. The control signals Tx_EN and Rx_EN are applied to the RF transmitting/receiving units 301 and 201, respectively, thereby reducing the power consumption in the each of the RF transmitting/receiving units 301 and 201.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

An impulse-based ultra wideband system according to the present invention can contribute to activation of the development of an UWB transmitter by applying power source to RF transmitting/receiving units only in a time interval in which an impulse signal having a short period and constituting a transmission/receiving data exists.

1. A low power ultra wideband (UWB) transmitter for an impulse-based UWB wireless system, the low power UWB transmitter comprising:
a baseband unit for modulating an impulse data signal and generating a power management control signal using a burst hopping information; and
an RF transmitting unit for transmitting a wireless signal and alternating between power-on/off states according to the power management control signal generated from the baseband unit.

2. The low power UWB transmitter of claim 1, wherein the baseband unit comprises:
a DAC for converting a digital signal into an analog signal on a transmission of data; and
a modem for modulating transmission/reception data in connection with the DAC,
wherein the modem generates the power management control signal based on a burst hopping information according to a burst position modulation scheme.

3. The low power UWB transmitter of claim 2, wherein the modem generates a power management control signal for always powering on the RF transmitting unit in an interval of transmitting/receiving a synchronization header of a transmission signal comprising a preamble and a start-of-frame delimiter (SFD).

4. The low power UWB transmitter of claim 2, wherein the modem generates a power management control signal for powering on the RF transmitting unit only during periods for generating a pulse and setting up the RF transmitting unit regarding intervals of a PHY header and a PHY service data unit (PSDU) of a transmission signal, and powering off the RF transmitting unit for other durations.

5. The low power UWB transmitter of claim 4, wherein the period when the RF transmitting unit is powered on is several tens of ns for each 1 us.

6. A low power UWB receiver for an impulse-based UWB wireless system, the low power UWB receiver comprising:
a baseband unit for demodulating an impulse data signal and generating a power management control signal using a burst hopping information; and
an RF receiving unit for receiving a wireless signal and alternating between power-on/off states according to the power management control signal generated from the baseband unit.

7. A method for operating a low power UWB transmitter for an impulse-based UWB wireless system, the method comprising:
generating an impulse data signal by modulating a transmission data according to a burst hopping information;
generating a power management control signal according to the burst hopping information;
transmitting the impulse data signal and the power management control signal into an RF transmitting unit; and
transmitting the impulse data signal by alternating power-on/off states of the RF transmitting unit according to the power management control signal.

8. The method of claim 7, wherein the generating of the power management control signal comprises:
distinguishing intervals of a transmission frame;
generating a control signal with respect to a synchronization header interval of the transmission interval; and
generating control signals with respect to a PHY header interval and a PSDU interval of the transmission frame.

9. The method of claim 8, wherein the generating of the control signals with respect to a PHY header interval and a PSDU interval comprises:
recognizing a location of a pulse in each symbol;
generating an enable signal for powering on the RF transmitting unit during a period comprising a duration of corresponding to the location of the pulse and a duration of stabilizing the RF transmitting unit; and
generating a disable signal for powering off the RF transmitting unit for other duration.

10. The method of claim 9, wherein the recognizing of the location of the pulse is performed based on a burst hopping information according to a burst position modulation-binary phase-shift keying (BPM-BPSK) scheme.

11. The method of claim 7, wherein the transmitting of the impulse data signal comprises:
maintaining the RF transmitting unit in a powered-on state in the synchronization header interval of a transmission signal; and
maintaining the RF transmitting unit in a powered-on state only while a pulse exists in the synchronization header interval of a transmission signal and in a powered-off state while a pulse is absent.

12. A method for operating a low power UWB receiver for an impulse-based UWB wireless system, the method comprising:
recognizing a wireless signal via an antenna;
maintaining an RF receiving unit in a powered-on state during a reception of a synchronization header comprising a preamble and a SFD;
generating a power management control signal using a burst hopping information;
alternating power-on/off states of the RF receiving unit according to the power management control signal during a reception of a PHY header and a PSDU after the reception of the synchronization header; and
demodulating data received from the RF receiving unit.
